(19) United States
(12) Patent Application Publication
(10) Pub. No.: US 2020/0129970 A1
(43) Pub. Date: Apr. 30, 2020

(54) METHOD FOR PREPARING TWO-DIMENSIONAL SHEET-SHAPED CU-MOF MATERIAL

(71) Applicant: NANJING TECH UNIVERSITY, Nanjing, Jiangsu (CN)

(72) Inventors: Hang LI, Nanjing (CN); Xiangyue XU, Nanjing (CN); Suoying ZHANG, Nanjing (CN); Zhuhong YANG, Nanjing (CN); Xiaohua LU, Nanjing (CN)

(73) Assignee: NANJING TECH UNIVERSITY, Nanjing, Jiangsu (CN)

(21) Appl. No.: 16/349,437

(22) PCT Filed: Jul. 20, 2018
(86) PCT No.: PCT/CN2018/096357

§ 371 Date: May 13, 2019

(30) Foreign Application Priority Data
Jun. 11, 2018 (CN) 201810596070.6

(51) Int. Cl. B01J 31/16; C07B 33/00

(52) U.S. Cl. CPC B01J 31/1691; B01J 2231/72; B01J 2531/16; C07B 33/00

(57) ABSTRACT

A method for preparing a two-dimensional sheet-shaped Cu-MOF material, includes mixing Cu-BTC with an alkaline solution at a certain solid-liquid ratio by stirring, reacting at a temperature of 25 to 120° C., filtering, washing with ionized water and drying under vacuum, to obtain a two-dimensional sheet-shaped Cu-MOF material, wherein the alkaline solution is at least one of urea, sodium carbonate, sodium bicarbonate, aqueous ammonia, sodium hydroxide or potassium hydroxide. The method has the characteristics of mild operation conditions, controllable transition process, high reaction yield and easy production at large scale, and exhibits excellent oxidation performance in styrene oxidation.

### BACKGROUND

### Technical Field

The present invention relates to the technical field of metal organic framework materials, and particularly to a method for preparing a two-dimensional sheet-shaped Cu-MOF material.

### Related Art

Due to the unique physical and chemical properties of two-dimensional materials, two-dimensional materials have been widely studied in recent years. So far, various two-dimensional materials studied include: graphene, graphene oxide, transition metal sulfide, metal oxide, boron nitride, and the like. Recently, the two-dimensional sheet-shaped metal organic framework (MOF) has been successfully prepared and become a new member of the two-dimensional material family. As is well known, MOF is a porous material with periodic network structure formed by self-assembly of metal ions or clusters and organic ligands, which has the advantages of adjustable structure functions, highly ordered pore structure and high specific surface area, and has great application prospects in the fields of gas storage, separation, catalysis, sensing, drug release and others. In addition to the majority of the structural features of the three-dimensional MOF material, the two-dimensional MOF material also has the advantages of high ion conductivity and high active site exposure, which has attracted great attentions of the researchers in the fields of catalysis, electrochemistry and sensing. However, the preparation methods of the two-dimensional MOF material mainly include the interface reaction method and the peeling method. These methods are often harsh and the output is extremely low, which greatly limits the further promotion and application of the two-dimensional MOF material. Therefore, there is an urgent need to develop a simple and mild method that is useful in large-scale production.

### SUMMARY

An object of the present invention is to provide a method for preparing a two-dimensional sheet-shaped Cu-MOF material, which realizes the rapid structure transition from three-dimensional Cu-BTC to two-dimensional sheet-shaped Cu-MOF by simple and easy-to-control solvent and temperature treatment. The method has the characteristics of mild operation conditions, controllable transition process, high reaction yield and easy production at large scale.

The object of the present invention is accomplished through the following specific technical solution.

A method for preparing a two-dimensional sheet-shaped Cu-MOF material includes mixing Cu-BTC with an alkaline solution at a certain solid-liquid ratio by stirring, reacting at a temperature of 25 to 120° C., filtering, washing with ionized water and drying under vacuum, to obtain a two-dimensional sheet-shaped Cu-MOF material, where the alkaline solution is at least one of urea, sodium carbonate, sodium bicarbonate, aqueous ammonia, sodium hydroxide or potassium hydroxide.

Further, the alkaline solution of the present invention has a pH of 7 to 12, and preferably 9 to 12. In the present invention, the morphology control of the two-dimensional sheet-shaped Cu-MOF can be realized by pH control under a specific solid-liquid ratio condition. Generally, the morphology of Cu-BTC in water transitions to nanowires, and the morphology of Cu-BTC in a solution transitions to a two-dimensional sheet-shaped at an optimum pH.

Further, the reaction temperature of the present invention is from 25 to 120° C. In the present invention, the size control and the adjustment of various structures of the two-dimensional sheet-shaped Cu-MOF can be realized by temperature control. The size and structure of the material produced generally vary significantly as the temperature changes.

Further, the reaction time of the present invention may be from 1 to 24 hrs, and preferably from 1 to 5 hrs.

Further, the solid-liquid ratio of the Cu-BTC to the alkaline solution in the present invention should be less than 1/30 g/ml. The present inventors have found that when the solid-liquid ratio goes beyond this range, the transition from three-dimensional Cu-BTC material to two-dimensional sheet-shaped Cu-MOF cannot be achieved no matter how the pH is adjusted. In order to achieve a better transition effect, preferably, 1/150≤solid-liquid ratio ≤1/40 g/ml, and more preferably 1/110≤solid-liquid ratio ≤1/50 g/ml. The solid-liquid ratio in the present invention is mainly affected by the pH of the alkaline solution, and the higher the pH value is, the larger the solid-liquid ratio will be. Preferably, when the pH of the alkaline solution is 7 to 9, 1/150≤solid-liquid ratio ≤1/80 g/ml, and preferably, 1/110≤solid-liquid ratio ≤1/90 g/ml. When the pH of the alkaline solution is 9 to 10.5, 1/100≤solid-liquid ratio <1/50 g/ml, and preferably, 1/90≤solid-liquid ratio ≤1/60 g/ml. When the pH of the alkaline solution is 10.5 to 12, 1/70≤solid-liquid ratio <1/30 g/ml, and preferably, 1/60≤solid-liquid ratio ≤1/40 g/ml.

The stirring, filtration, washing and drying mentioned in the present invention can be carried out by a method conventional in the art without any influence on the transition.

The present invention also provides a two-dimensional sheet-shaped Cu-MOF material prepared by the method.

The present invention also provides the use of the two-dimensional sheet-shaped Cu-MOF material in the field of catalysis.

The Cu-BTC described in this patent refers to a MOF material having a three-dimensional structure which has been industrialized in the prior art, and has a CAS number of 51937-85-0.

The two-dimensional sheet-shaped Cu-MOF according to the present invention is a general term for a plurality of compounds having a two-dimensional sheet-shaped structure formed by the coordination assembly of Cu and trimesic acid.

The present invention has the following beneficial effects.

(1) The two-dimensional sheet-shaped Cu-MOF prepared by the present invention has more exposed active sites and higher catalytic activity than the conventional three-dimensional Cu-BTC material.

(2) The reaction process of the present invention can achieve the transition simply by virtue of pH and solid-liquid ratio. The reaction can be carried out at normal temperature and pressure, the reaction conditions are mild, the process is simple, the yield is high and scaled-up production can be easily achieved in the industry.

(3) In the present invention, the size control and the adjustment of various structures of the two-dimensional sheet-shaped Cu-MOF can also be realized by controlling the reaction temperature.

### BRIEF DESCRIPTION OF THE DRAWINGS

FIG. 1 compares the XRD patterns of the crystal structures before and after transition at various temperatures (25° C., 80° C., and 120° C.);

FIG. 2 is a scanning electron microscopy (SEM) image of the crystal morphology after transition at various temperatures (25° C., and 80° C.); and

FIG. 3 is a scanning electron microscopy (SEM) image of the crystal morphology after transition at different solid-liquid ratios.

### DETAILED DESCRIPTION

The present invention will be further described below by way of examples. The following examples are provided for a better understanding of the present invention; however, the present invention is not limited thereto.

The methods given in examples below are all conventional methods, unless it is otherwise stated; and the reagents and raw materials are all commercially available unless otherwise indicated.

The specific mode of catalytic oxidation of styrene in the following examples is as follows:

10 mg of a catalyst is fed to a 40 ml stoppered glass flask, 4 ml of acetonitrile, 2 mmol of styrene and 6 mmol of t-butyl hydroperoxide (TBHP) are added, respectively, and stirred at 75° C. for 5 h.

### Example 1

Cu-BTC and an urea solution with pH=9 were mixed at a solid-liquid ratio of 1/100 g/ml, stirred at 25° C. for 5 hrs, filtered, washed and dried to obtain a two-dimensional sheet-shaped Cu-MOF-25. The thickness was from 30 nm to 100 nm. In the catalytic oxidation experiment of styrene, the conversion rate reached 98.97% after 5 h reaction.

### Example 2

Cu-BTC and a sodium hydroxide solution with pH=10 were mixed at a solid-liquid ratio of 1/80 g/ml, stirred at 80° C. for 2 hrs, filtered, washed and dried to obtain a two-dimensional sheet-shaped Cu-MOF-80. The thickness was from 200 nm to 300 nm. In the catalytic oxidation experiment of styrene, the conversion rate reached 97.42% after 5 h reaction.

### Example 3

Cu-BTC and aqueous ammonia with pH=12 were mixed at a solid-liquid ratio of 1/50 g/ml, stirred at 120° C. for 1 hr, filtered, washed and dried to obtain a two-dimensional sheet-shaped Cu-MOF-120. The thickness was from 400 nm to 500 nm. In the catalytic oxidation experiment of styrene, the conversion rate reached 97.15% after 5 h reaction.

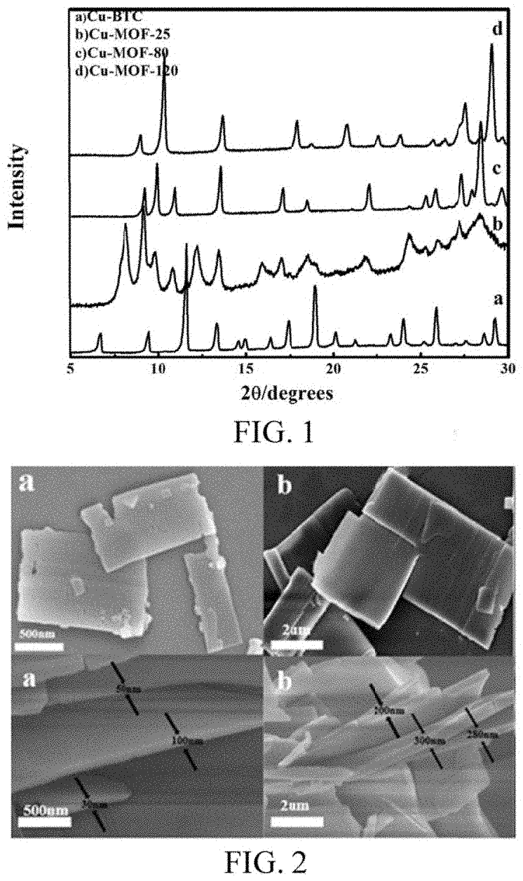

FIG. 1 compares the XRD patterns of the crystal structures before and after transition of Cu-BTC in the above examples, in which a) is Cu-BTC before transition, b) is an XRD pattern of Cu-MOF after transition at 25° C. in Example 1, c) is an XRD pattern of Cu-MOF after transition at 80° C. in Example 2, and d) is an XRD pattern of Cu-MOF after transition at 120° C. in Example 3. A scanning electron microscopy (SEM) image of the crystal morphology after the transition is shown in FIG. 2, where a is an SEM image of Cu-MOF after transition at 25° C. in Example 1, and b is an SEM image of Cu-MOF after transition at 80° C. in Example 2.

### Comparative Example 1

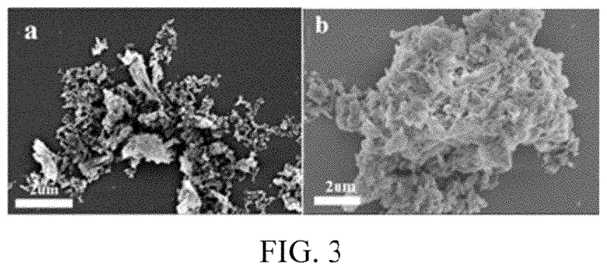

Cu-BTC and an urea solution with pH=12 were mixed at a solid-liquid ratio of 1/30 g/ml, stirred at 120° C. for 1 hr, filtered, washed, and dried. However, Cu-BTC fails to transition to two-dimensional Cu-MOF, as shown in FIG. 3a.

### Comparative Example 2

Cu-BTC and an sodium hydroxide solution with pH=10 were mixed at a solid-liquid ratio of 1/40 g/ml, stirred at 80° C. for 2 hr, filtered, washed, and dried. However, Cu-BTC fails to transition to two-dimensional Cu-MOF, as shown in FIG. 3a.

### Comparative Example 3

When the performance of Cu-BTC was characterized by the conversion rate at 5 h of catalytic oxidation of styrene, the conversion rate was 42.32%. It can be seen that the two-dimensional sheet-shaped MOF material has more active sites and higher catalytic activity than the conventional MOF material.

1. A method for preparing a two-dimensional sheet-shaped Cu-MOF material, comprising mixing Cu-BTC with an alkaline solution at a certain solid-liquid ratio by stirring, reacting at a temperature of 25 to 120° C., filtering, washing with ionized water and drying under vacuum, to obtain a two-dimensional sheet-shaped Cu-MOF material, wherein the alkaline solution is at least one of urea, sodium carbonate, sodium bicarbonate, aqueous ammonia, sodium hydroxide or potassium hydroxide.

2. The method according to claim 1, wherein the raw material Cu-BTC refers to a MOF material having a three-dimensional structure which has been industrialized in the prior art, and has a CAS number of 51937-85-0.

3. The method according to claim 1, wherein the two-dimensional sheet-shaped Cu-MOF is a general term for a plurality of compounds having a two-dimensional sheet-shaped structure formed by the coordination assembly of Cu and trimesic acid.

4. The method according to claim 1, wherein the solid-liquid ratio of the Cu-BTC to the alkaline solution is less than 1/30 g/ml.

5. The method according to claim 1, wherein the solid-liquid ratio of the Cu-BTC to the alkaline solution is such that when the pH of the alkaline solution is 7 to 9, 1/150≤solid-liquid ratio ≤1/80 g/ml; when the pH of the alkaline solution is 9 to 10.5, 1/100≤solid-liquid ratio <1/50 g/ml; and when the pH of the alkaline solution is 10.5 to 12, 1/70≤solid-liquid ratio <1/30 g/ml.

6. The method according to claim 1, wherein the pH of the alkaline solution is 7 to 12.

7. The method according to claim 1, wherein the pH of the alkaline solution is 9 to 12.

8. The method according to claim 1, wherein the reaction temperature is 25 to 120° C.

9. The method according to claim 1, wherein the reaction time is 1-24 hrs.

10. The method according to claim 9, wherein the reaction time is 1-5 hrs.

11. The method according to claim 1, wherein the solid-liquid ratio of the Cu-BTC to the alkaline solution is 1/150≤solid-liquid ratio ≤1/40 g/ml.

12. The method according to claim 1, wherein the solid-liquid ratio of the Cu-BTC to the alkaline solution is 1/110≤solid-liquid ratio ≤1/50 g/ml.

13. The method according to claim 1, wherein the solid-liquid ratio of the Cu-BTC to the alkaline solution is such that when the pH of the alkaline solution is 7 to 9, 1/150≤solid-liquid ratio ≤1/80 g/ml; when the pH of the alkaline solution is 9 to 10.5, 1/100≤solid-liquid ratio <1/50 g/ml; and when the pH of the alkaline solution is 10.5 to 12, 1/60≤solid-liquid ratio ≤1/40 g/ml.

14. The method according to claim 1, wherein the solid-liquid ratio of the Cu-BTC to the alkaline solution is such that when the pH of the alkaline solution is 7 to 9, 1/150≤solid-liquid ratio ≤1/80 g/ml; when the pH of the alkaline solution is 9 to 10.5, 1/90≤solid-liquid ratio ≤1/60 g/ml; and when the pH of the alkaline solution is 10.5 to 12, 1/70≤solid-liquid ratio <1/30 g/ml.

15. The method according to claim 1, wherein the solid-liquid ratio of the Cu-BTC to the alkaline solution is such that when the pH of the alkaline solution is 7 to 9, 1/150≤solid-liquid ratio ≤1/80 g/ml; when the pH of the alkaline solution is 9 to 10.5, 1/90≤solid-liquid ratio ≤1/60 g/ml; and when the pH of the alkaline solution is 10.5 to 12, 1/60≤solid-liquid ratio ≤1/40 g/ml.

16. The method according to claim 1, wherein the solid-liquid ratio of the Cu-BTC to the alkaline solution is such that when the pH of the alkaline solution is 7 to 9, 1/110≤solid-liquid ratio ≤1/90 g/ml; when the pH of the alkaline solution is 9 to 10.5, 1/100≤solid-liquid ratio <1/50 g/ml; and when the pH of the alkaline solution is 10.5 to 12, 1/70≤solid-liquid ratio <1/30 g/ml.

17. The method according to claim 1, wherein the solid-liquid ratio of the Cu-BTC to the alkaline solution is such that when the pH of the alkaline solution is 7 to 9, 1/110≤solid-liquid ratio ≤1/90 g/ml; when the pH of the alkaline solution is 9 to 10.5, 1/100≤solid-liquid ratio <1/50 g/ml; and when the pH of the alkaline solution is 10.5 to 12, 1/60≤solid-liquid ratio ≤1/40 g/ml.

18. The method according to claim 1, wherein the solid-liquid ratio of the Cu-BTC to the alkaline solution is such that when the pH of the alkaline solution is 7 to 9, 1/110≤solid-liquid ratio ≤1/90 g/ml; when the pH of the alkaline solution is 9 to 10.5, 1/90≤solid-liquid ratio ≤1/60 g/ml; and when the pH of the alkaline solution is 10.5 to 12, 1/70≤solid-liquid ratio <1/30 g/ml.

19. The method according to claim 1, wherein the solid-liquid ratio of the Cu-BTC to the alkaline solution is such that when the pH of the alkaline solution is 7 to 9, 1/110≤solid-liquid ratio ≤1/90 g/ml; when the pH of the alkaline solution is 9 to 10.5, 1/90≤solid-liquid ratio ≤1/60 g/ml; and when the pH of the alkaline solution is 10.5 to 12, 1/60≤solid-liquid ratio ≤1/40 g/ml.
